(19) United States
(12) Patent Application Publication
(10) Pub. No.: US 2018/0226782 A1
(43) Pub. Date: Aug. 9, 2018

(54) PASSIVE COMPOUND STRONG-IONIZATION DISCHARGING PLASMA LIGHTNING REJECTION DEVICE

(71) Applicant: Kunsheng Wang, Kunming, Yunnan (CN)

(72) Inventor: Kunsheng Wang, Kunming, Yunnan (CN)

(21) Appl. No.: 15/737,570

(22) PCT Filed: Jul. 16, 2015
(86) PCT No.: PCT/CN2015/084226

§ 371 Date: Apr. 16, 2018

(30) Foreign Application Priority Data
Jun. 18, 2015 (CN) 201510340702.9

(51) Int. Cl. H02G 13/00; H01T 19/00

(52) U.S. Cl. CPC H02G 13/80; H01T 19/00

(57) ABSTRACT

A passive compound strong-ionization discharging plasma lightning rejection device. The device comprises a thundercloud charge gathering and eliminating unit, a strong-ionization discharging unit and an grounding conductor. A discharging electrode of the strong-ionization discharging unit has two poles, pole A being combined with the thundercloud charge gathering and eliminating unit into one piece, pole B being connected to the grounding conductor, and a discharging gap between the two poles. This device is excited by a thundercloud electric field , generates scores of mC/s dissipation electric charges by means of compound strong-ionization discharging, efficiently neutralizes cloud and earth electric charges ±Q gathered by the thundercloud charge gathering and eliminating unit and the grounding conductor, and effectively restrains the voltage V=Q/C of equivalent capacitance C between the cloud and the earth from increasing, without being charged by the thundercloud to the extent of being broken down by discharging towards the earth.

### TECHNICAL FIELD

The invention relates to the technical field of lightning protection array in lightning protection technology, and particularly relates to a lightning rejection device with the plasma passively produced by the compound strong-ionization discharging for high-efficiently gathering and eliminating the cloud and ground charges under a thundercloud electric field, so that the direct-lightning strike can be effectively avoided.

### BACKGROUND

At present, in the technical field of direct-lightning strike protection, the typical lightning protection devices are as follows: lightning rod, lightning eliminating array and compound active and passive plasma lightning rejection device. Among them, the lightning rod is commonly known as “lightning avoiding rod” in Chinese, but according to the latest national standard “Design Code for Protection of Structures against Lightning”, “lightning rod” is officially corrected as “lightning attracting rod” in Chinese to be fit for the English name of Lightning Rod and abbreviated as LR. A derived device of LR is Early Streamer Emission and is abbreviated as ESE. Lightning Eliminating Array, which is known as Lightning Eliminator, is abbreviated as LEA. Compound Active and Passive Plasma Lightning Rejection Device is abbreviated as CPLR.

LR has been continuously used for more than 250 years since it was invented by Benjamin Franklin and its principle of lightning protection is as follows. The thundercloud electric field is excited by utilizing the point effect on the tip of LR, and an upward leader is excited to attract the downward leader of lightning, and then the LR is broke down by lightning stroke and the lightning struck current releases through the grounding conductor to the ground to protect the objects from lightning stroke within the scope of protection radius which is about equal to the installation height of LR. However, the harms are caused by discharging the lightning current into the ground, such as back flashover, strong electromagnetic radiation, inducting overvoltage, personnel's step voltage and touch voltage, especially the serious harms to electronic equipment and system in the information Age. In addition, LR has some problems such as the lack of ions in the tip-excited upward leader and cannot attract the lightning with smaller current stably, causing its shielding failure for the protected object. For this reason, the various types of ESE represented by French products are derived. Usually, the auxiliary electrodes, discharge gap, energy storage inductor and capacitor are provided to emit their stored ions or high voltage pulse on the lightning rod, so as to make the tip of the lightning rod early and accurately excite the upward leader to attract the downward leader of lightning strike. In order to prevent the stored ions from spreading to the surrounding space, wrapping insulating material around the lightning rod is used and only allows the tip of the lightning rod to emit the stored ions intensively and to attract lightning earlier and more accurately.

LEA abandoned the harms of LR in discharging lightning current into the ground but absorbed the advantage of LR, that is, to attract lightning with its higher electric field strength produced by the semi-point effect on its multi-rods and make the protected objects to be placed in a relatively lower electric field strength without being broke down by lightning stroke. Therefore, it has not only higher electric field strength to gather thundercloud electric field and charge, but also high efficiency to consume the gathered thundercloud charge without being broke down by lightning so that the protected objects are in the low electric field strength without being struck down by lightning, which is the development direction of the direct lightning protection device. LEA is just constructed according to the development direction.

LEA was used by NASA in 1971 for the lightning protection of Apollo launch pad and its “non-lightning grounding” mechanism was used to solve the electronic system damages caused by the induced lightning stroke from Lightning Electromagnetic Pulse (LEMP) of traditional LR with “lightning grounding” mechanism. The lightning protection mechanism of LEA is called “charge transfer method” by NASA, which is also known as “charge neutralization method” in China. LEA is usually constructed as American-style with multi short-rods (the hemispherical radiating array with hundreds to thousands of short metal rods of about 300 mm in length) and Chinese-style with less long-rods (the hemispherical radiation array with dozens of long metal rods of several meters in length and with several short auxiliary tips at the top of the rods) developed by Peng Yao, etc. in Yunnan Electric Power Test Center in 1979.

FIG. 1 shows a structure diagram of a less long-rods LEA in the prior art. The LEA comprises a base and a less long-rod array mounted on the base with an array arrangement. From the inducting of thundercloud electric field, plasma is produced by the glow discharge on the tips of the array rods. Under the attracting of the thundercloud electric field and its inducted hetero electric field on the ground, the hetero-ions in the plasma are separated and drifted towards the hetero-electric field and diffuse towards the region with lower ion density in the surrounding space. In fact, due to the thundercloud electric field charges gathered by the tips of LEA and the induced ground electric field charges gathered by the grounding conductor and the steel tower of LEA have been neutralized mostly by the hetero-ions of the plasma near the array tips and through the grounding conductor and the steel tower. Therefore, the thundercloud electric field and its induced ground electric field are equalized and weakened to form a forced equalized electric field in the surrounding space and then the induced electric field strengths of the objects on the ground and the LEA itself cannot be excited by the thundercloud electric field to the breakdown level.

Thus, the structure and the aim of LEA are fit for increasing the lightning breakdown voltage withstand level as high as possible. On the contrary, the structure and the aim of ESE are fit for decreasing the lightning breakdown voltage withstand level as low as possible.

However, while the LEA forms a forced equalized electric field in the surrounding space, it also weakens the electric field strength of its own tips. Accordingly, the ability of producing plasma is reduced, and the self-shielding effect of ionization discharging is presented. The improvement cannot be achieved even increasing the number of the rods in the array, because the factor of determining LEA's ability for eliminating lightning is the plasma dissipation current, but the self-shielding effect limits the further increasing of the plasma dissipation current. As a result, the existing LEA's ability of eliminating lightning is limited. With the best structure and operation environment (e.g. in the high elevation area where ionization is easier to achieve), the plasma dissipation current produced by LEA during the lightning activity is also less than 2 mA. While in the dynamic weather and environmental conditions (such as low elevation area where ionization is not easier to achieve), the plasma dissipation current produced by LEA during the lightning activity will be even smaller and not enough to eliminate lightning stably, so that the probability of lightning breakdown for the LEA itself or the protected objects in its protection scope is higher and most people in the field of lightning protection have disputed or negative attitude to LES. Too small plasma dissipation current is the fatal problem of practical application for LEA.

The Chinese patent 200410022185.2 filed on Mar. 29, 2004 by the inventor of this invention disclosed a compound active and passive plasma lightning rejection method and device (CPLR). FIG. 2 is the structural block diagram in the prior art. In the device, the lightning fore-alarming signal unit 1 sends the starting signal to the active plasma generation unit 2 and the air flowing source unit 3. The air flowing source unit 3 operates to draw air from atmosphere or other applicable gases and transport it to the active plasma generator unit 2 for ionization. The high density plasma generated by ionizing air or other applicable gases is transported to the tubes of the lightning rods 4 and drained out from the tops of the tubes. Both the plasma produced by LEA's ionization discharging at the end of the array tips under thundercloud induction and the high density plasma generated by active strong-ionization discharging are used for compound dissipation at the end of the hollow tubes to compensate the shortage of the dissipation current from LEA. The advantage of CPLR is that it can be started earlier (when the distance from the thundercloud activity center to the protected object is about 5 km with 15 min drifting) to generate high density plasma actively at the favorable time that the thundercloud electric field is still weaker.

However, CPLR exists some problems, such as the technique of the active plasma generator is complicated; power supply is difficult on some occasions, especially the power cut off during the lightning activity the uninterruptible power supply (UPS) needs to be provided; its volume is relatively large; overall cost is higher; the maintenance is need for high-frequency and high voltage power electronic parts and electronic control system; and its dissipation current emitted by active plasma generator unit is relatively small; and then its application scope is limited. In view of the above problems of CPLR in the way of generating plasma actively and in order to use the passive way for efficiently gathering and eliminating thundercloud charges, through many laboratory simulation tests, studies and operation tests in heavy thunderstorm areas the inventor of this application developed the Device of Passive Compound Strong Ionization Discharge Plasma for Lightning Rejection (PCPLR) energized by thundercloud electric field completely to solve the existing technical problems.

### CONTENTS OF THE INVENTION

The objective of the invention is to provide a lightning rejection device with the plasma passively produced by the compound strong-ionization discharging and so that it can be energized by the thundercloud electric field to produce and dissipate plasma current for efficiently gathering and eliminating the thundercloud and ground charges and then avoiding the direct-lightning strike within the wide protection scope.

The invention is to realize its objective based on the following technical solution:

A lightning rejection device with the plasma passively produced by the compound strong-ionization discharging comprises a thundercloud charge gathering and eliminating unit, a strong-ionization discharging unit and a grounding conductor, wherein the strong-ionization discharging unit has two electrodes, electrode A being connected with the thundercloud charge gathering and eliminating unit, electrode B being connected with the grounding conductor, and the discharging gap between the two electrodes being separated and fixed by an insulating supporter; the thundercloud charge gathering and eliminating unit is a lightning elimination array.

The described electrode A of the discharge electrodes of the strong-ionization discharging unit is an arc surface electrode, a plate electrode, a thin line electrode or a annular electrode, and electrode B is also of an arc surface electrode, a flat plate electrode, a thin line electrode or a annular electrode. The edge of the flat plate electrode has an arc shape for eliminating the intensification effect of the edge electric field.

The described electrode A as an annular electrode is an annular plate electrode, an annular arc surface electrode or an annular thin line electrode, while the electrode B is an annular plate electrode, an annular arc surface electrode or an annular thin line electrode; the annular electrode A and the annular electrode B are concentric rings. The edge of the annular plate electrode has an arc shape for eliminating the intensification effect of the edge electric field.

The described electrode A and electrode B are thin line electrodes and the thin line electrode is a single loop thin line or multi-loop thin lines, and the cross section radius R of the single loop thin line electrode is about 0.1 mm˜10 mm.

The described electrode A and electrode B are thin line electrodes, the thin line electrode is a linear protrusion provided on the plate plane of the plate electrode and the arc electrode, the linear protrusion is a fine circular line, a semicircle line, a tooth tip line, a section line of a thin plate or a edge angle line of a thick plate, and the linear protrusion has a cross section radius R of about 0.1 mm˜10 mm, causing the thin line effect in ionizing discharging; the thin line electrode is axially perpendicular to the flat plate electrode with equivalent effect of a tip electrode axially perpendicular to the flat plate electrode.

The described electrode A is a multi-thin-line electrode, electrode B is a flat plate electrode or a arc plate electrode and the axis of the multi-thin-line electrode is perpendicular to the flat plate electrode or perpendicular to the normal of the arc plate electrode; the edge of the flat plate electrode or arc plate electrode has a circular arc shape for eliminating the intensification effect of the edge electric field.

An additional insulating dielectric layer can be added between electrode A and electrode B of the described strong-ionization discharging unit and the dielectric layer can further increase the gap breakdown voltage.

The lightning-eliminating array comprises an arc cover-shaped base and a dozen to hundreds of array rods; these array rods are mounted on the outer wall of the base. The array rods can be metal solid rods or metal hollow tubes.

The base is a hollow metal arc cover, the described discharge electrodes of the strong-ionization discharging unit are installed inside of the arc-cover and the inner wall of the base is one electrode of the discharge electrodes of the strong-ionization discharging unit; The base is fixed on an insulating supporter provided on the other electrode of the discharge electrodes of the strong-ionization discharging unit. The discharge electrode is fixed on a lightning rejection tower in a seat structure. The bottom of the base is provided with an inlet, and the atmospheric updraft enters the base along the inlet, flowing through the discharge electrodes and exiting to the space through the outlet of each array tubes.

According to the technical solution of the invention, the resulting advantageous effect is that: the thundercloud charge gathering and eliminating unit from the prior passively producing plasma with LEA is combined with the passive strong-ionization discharging unit from a new plasma producing technology with “multi-thin-line effect” strong-ionization discharging, and connecting with the grounding conductor. Energized by the thundercloud electric field, the compound strong-ionization discharging unit produces several 10 mC/s dissipation electric charge flow (i.e. several 10 mA dissipation current), efficiently neutralizes the cloud and ground charges ±Q gathered by the lightning cloud electric charge gathering and eliminating unit and the grounding conductor, and effectively restrains the voltage V=Q/C of the equivalent capacitor C between the cloud and the ground from increasing without being charged by the lightning cloud electric field to the extent of being struck down to ground, i.e. the objects and the PLR itself within the wider scope of greater than 84° protection angle (i.e., the protection radius is 10 times of the PLR installation height) under the lightning cloud electric field are protected from thundercloud electric field breakdown.

The invention of PCPLR integrates the advantages of LR, LEA and CPLR technologies, and solves their main problems respectively, becoming a new generation of direct-lightning strike protection device.

As LEA is renewed and transformed by PCPLR, PCPLR has further increased the breakdown voltage withstand level and its breakdown voltage withstand level is more than 4.7 times that of LR, without being broken down by lightning.

The present invention is suitable for the direct-lightning strike protection of all kinds of fixed and movable objects.

In order to better understand and describe the conception, working principle and implementation effect of the invention, the following detailed illustration is made by means of the embodiments in combination with drawings.

### DESCRIPTION OF THE DRAWINGS

FIG. 1 is the structure diagram of the lightning-elimination array in the prior art LEA;

FIG. 2 is the structure block diagram of the prior art CPLR;

FIG. 3 is the structure block diagram of the invention;

FIG. 4 is the schematic diagram of the installation structure of the invention;

FIG. 5 is the first embodiment of the strong-ionization discharging unit of the invention, which shows that the schematic diagram of the concentric double annular arc cross section electrodes of the strong-ionization discharging unit;

FIG. 6A is the second embodiment of the strong-ionization discharging unit of the invention, which shows the schematic diagram that the two electrodes of the strong-ionization discharging unit are the flat plate electrodes with the structure for eliminating the intensification effect of the edge electric field;

FIG. 6B is the schematic diagram of the dielectric layer fixed in the gap between the flat plate electrodes with the discharging unit in FIG. 6A;

FIG. 7A is the third embodiment of the strong-ionization discharging unit of the invention, which shows the schematic diagram that the annular thin-line electrode of the strong-ionization discharging unit is connected with the thundercloud charge gathering and eliminating unit and the other annular plate electrode concentric with the annular thin-line electrode is connected with the grounding conductor;

FIG. 7B is the schematic diagram of the strong-ionization discharging unit which is similar to FIG. 7A, showing that the annular thin-line electrode of the discharging unit is electrically connected with the grounding conductor and another electrode is an annular plate electrode connected with the thundercloud charge gathering and eliminating unit;

FIG. 8A is the fourth embodiment of the strong-ionization discharging unit of the invention, showing the schematic diagram that the vertical cylindrical multi thin-line electrode is connected with the thundercloud charge gathering and eliminating unit, and the other electrode is a circular plate electrode connected with the grounding conductor;

FIG. 8B is the schematic diagram of the strong-ionization discharging unit which is similar to FIG. 8A, showing that the vertical cylindrical multi-thin-line electrode is connected with the grounding conductor, and the other electrode is a circular plate electrode connected with the thundercloud charge gathering and eliminating unit;

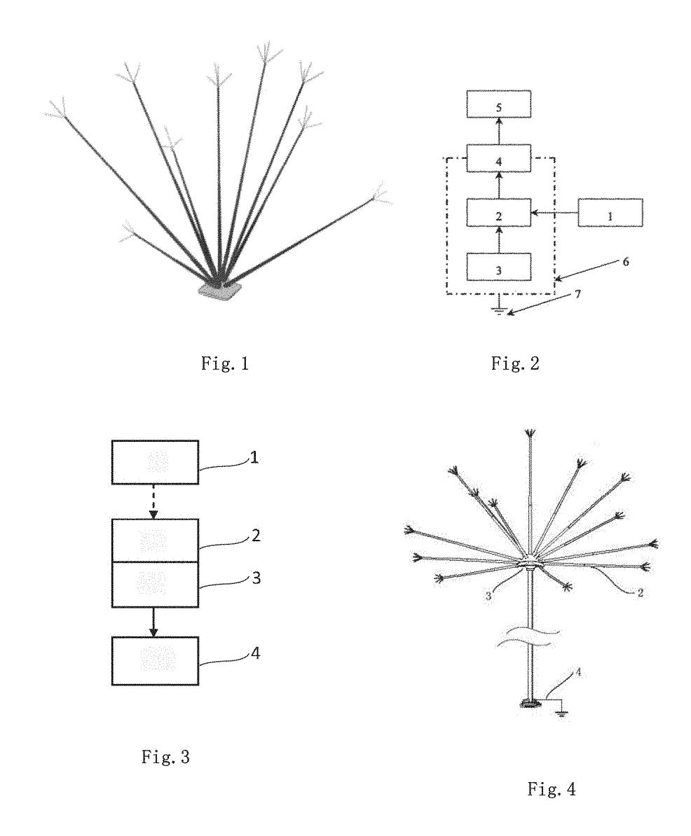

In the Drawings: 1. Thundercloud electric field; 2. Thundercloud charge gathering and eliminating unit; 3. Strong-ionization discharging unit; 4. Grounding conductor.

### EMBODIMENTS

FIG. 3 is the structure block diagram of the invention. As shown in FIG. 3, a lightning rejection device with the plasma passively produced by the compound strong-ionization discharging comprises a thundercloud charge gathering and eliminating unit 2, a strong-ionization discharging unit 3 and a grounding conductor 4. The discharging electrodes of the strong-ionization discharging unit 3 comprises electrode A and electrode B, wherein electrode A is connected with the base of the thundercloud charge gathering and eliminating unit 2, electrode B is fixed on the lightning rejection tower in a seat structure and connected to the grounding conductor 4, and a discharging gap is isolated and fixed between the two electrodes by an insulating supporter.

The grounding conductor 4 is connected to the ground or the equivalent reference ground composed of the floating-grounding metal plate.

Under the energizing of thundercloud electric field 1: the external components of thundercloud charge gathering and eliminating unit 2 are induced by the thundercloud electric field to form a hetero electric field on the tips of the array rods and produce the ionized discharging plasma between the two hetero electric fields; the internal wall of the thundercloud charge gathering and eliminating unit 2 and its combined discharging electrode A of the strong-ionization discharging unit 3 produce the hetero electric field against the external electric field of the external components, i.e., the same electric field polarity as that of the thundercloud electric field. At the same time, as induced by the thundercloud electric field, the grounding conductor 4 and the ground produce the hetero electric field, and then the electric field of the electrode B of the strong-ionization discharge unit 3 connected with the grounding conductor 4 is with hetero against the thundercloud electric field, and so that, the electric fields of the two hetero electrodes discharge in their gap, and the strong electric field and strong ionization discharging plasmas are produced between the electrodes owing to the optimizing for the structure and the clearance size of the electrodes. Because the strong-ionization discharging unit 3 is connected in series between the thundercloud charge gathering and eliminating unit 2 and the grounding conductor unit 4, the level to produce strong electric field strength and strong ionization discharging plasma dissipation current for the thundercloud charge gathering and eliminating unit 2 and for the grounding conductor 4 is raised directly. The plasmas generated by the compound strong ionization discharging in this device dissipate around the tips of the array rods and the strong ionization discharge electrodes. Under the attraction of the thundercloud electric field and its induced hetero electric field on the ground objects, the positive and negative ions of the plasma are separated and individually drift towards the hetero electric field and diffuse towards the region with low density ions, and neutralize the hetero thundercloud charges and the charges induced on the ground objects around PLR, i.e., energized by the thundercloud electric field, the compound strong-ionization discharging unit produces several 10 mA dissipation current, efficiently neutralizes the cloud and ground charges ±Q and effectively restrains the voltage V=Q/C of the equivalent capacitor C between the cloud and the ground from increasing without being charged by the lightning cloud electric field to the extent of being struck down to ground, i.e. the objects and the PCPLR itself within the wider scope of greater than 84° protection angle (i.e., the protection radius is 10 times of the PCPLR installation height) under the lightning cloud electric field are protected from thundercloud electric field breakdown.

FIG. 4 is the schematic diagram of the installation structure of the invention: in which the PCPLR is mounted on the top of the tower at the highest point rising from the ground to the protected area, and it can also be installed on the top of the tower of the tallest buildings or the protected transmission line tower within the protected scope; In the figure, the thundercloud charge gathering and eliminating unit 2 is connected with the strong-ionization discharging unit 3 and fixed at the top of the elevated tower through the strong-ionization discharging unit 3, and the grounding electrode of the strong-ionization discharging unit 3 is connected through a lead wire to the grounding conductor 4.

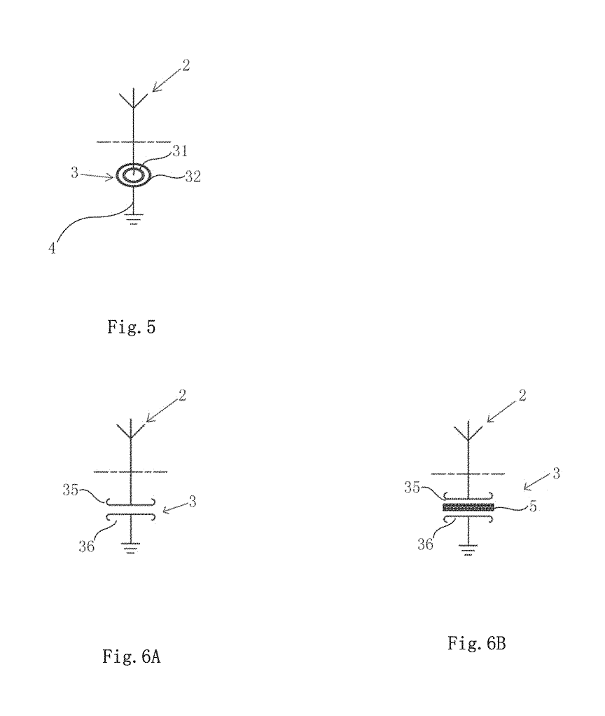

The strong-ionization discharging unit 3 of the invention can have various forms of structure. FIG. 5 is the first embodiment of the strong-ionization discharging unit of the invention, it shows the schematic diagram of the concentric double ring arc cross section electrode of the strong-ionization discharge unit; As shown in FIG. 5, the concentric double ring arc section electrode includes one electrode A connected with the base of the thundercloud gathering and eliminating unit 2, and the outer circumferential surface of the electrode A is the outer annular curve surface 31; the inner circumferential surface of another electrode B connected with the grounding conductor 4 is the inner annular curve surface 32. The inner annular curve surface 32 is placed outside the outer annular curve surface 31, the outer annular curve surface 31 and the inner annular curve surface 32 are concentric, and the discharge gap is isolated and fixed with the insulating support between the outer annular curve surface 31 and the inner annular curve surface 32. In order to further improve the voltage breakdown level between the two electrodes, the insulating dielectric layer can be set between the outer annular curve surface 31 and the inner annular curve surface 32 according to the need.

FIG. 5 is the first embodiment. According to the actual need, the outer annular surface electrode 31 of the strong-ionization discharging unit 3 can be electrically connected with the grounding conductor 4, and the inner annular surface electrode 32 and the base of the thundercloud charge gathering and eliminating unit 2 can be connected.

FIG. 6A is the second embodiment of the strong-ionization discharging unit of the invention, which shows that the two electrodes of the discharge electrodes of the strong-ionization discharging unit are as shown in the schematic diagram with the plate electrodes to eliminate the intensification effect of the edge electric field. As shown in the figure, one flat plate electrode 35 is connected with the thundercloud charge gathering and eliminating unit 2 and another flat plate electrode 36 is connected with the grounding conductor 4. In order to avoid the discharge breakdown of the marginal electric field intensification effect, the circumferences of the discharge surfaces of the flat plate electrode A 35 and the flat plate electrode B 36 are respectively constructed as circular arc curling edge. In the presence of thundercloud electric field, the inner side electric field of the flat plate electrode 35 and thundercloud electric field are the same polar electric field, the electric field of the flat plate electrode B 36) and the induced ground electric field are the same polarity electric field, and the ionization discharging is generated between the flat plate electrode A 35 and the flat plate electrode B 36 due to the inverse polarity of their electric fields.

FIG. 6B is the schematic diagram of the plate electrode gap being inserted with the insulating dielectric layer for the discharging unit in the FIG. 6A; For further improving the voltage breakdown level between the two electrodes, according to the needs, the insulating dielectric layer 5 can be inserted into the gap between the flat plate electrode A 35 and the flat plate electrode 36. The discharging gap between the discharging electrodes is separated and fixed by an insulating support, the strong-ionization discharging unit is fixed to the top of the tower through the grounding electrode and the following embodiments are all the same and it is not necessary to be repeatedly described.

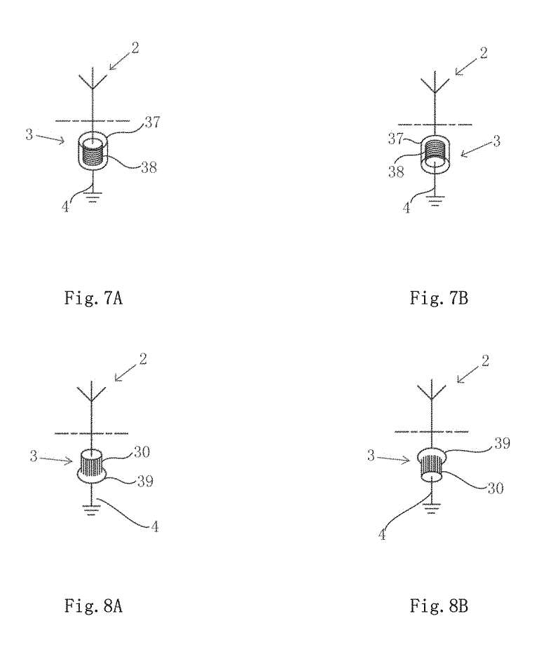

FIG. 7A is the third embodiment of the strong-ionization discharging unit of the invention, showing the schematic diagram that the annular thin line electrode of the strong-ionization discharging unit is connected with the thundercloud charge gathering and eliminating unit; As shown in the figure, the described electrode B of the strong-ionization discharging unit is the annular plate 37 and the annular plate 37 is connected with the grounding conductor 4; Another electrode A is the annular thin line electrode 38 which is concentric with the annular plate 37. The annular thin line electrode is connected with the thundercloud charge gathering and eliminating unit 2.

FIG. 7B is the strong-ionization discharging unit which is similar as that in FIG. 7A, showing the schematic diagram that the annular thin line electrode of the strong-ionization discharge unit is electrically connected with the grounding conductor; As shown in the figure, the described electrode A of the strong-ionization discharging unit is the annular plate 37 and the annular plate 37 is connected with the thundercloud charge gathering and eliminating unit 2; another electrode B is the circular thin line electrode 38 which is concentric with the annular plate 37. The annular thin line electrode is connected with the grounding conductor 4.

The radius R of the thin line section circular arc of the thin line electrode 38 is about 0.1 mm˜10 mm.

The thin line of the thin line electrode 38 generally comprises: protrusions provided on the plate plane of a flat plate electrode and an arc electrode, the protrusions includes a thin circular line, a semicircle line, a tooth tip line, a section line of a thin plate, a edge line of a thick plate. The radius R of the cross section circular arc of the protrusions is about 0.1 mm˜10 mm, which can produce a thin line effect in ionization discharging.

In the embodiment shown in FIGS. 7A and 7B, in order to further increase the voltage breakdown level between the two electrodes, the insulating dielectric layer can be inserted between the annular electrodes 37 and 38 according to the need.

FIG. 8A is the fourth embodiment of the strong-ionization discharging unit of the invention, showing the schematic diagram that the cylindrical thin line electrode is vertical to the plate electrode and is connected with the thundercloud charge gathering and eliminating unit; As shown in the figure, the described electrode B of the strong-ionization discharging unit is the flat plate electrode 39, which is electrically connected with the grounding conductor 4; Another electrode A is the cylindrical thin line electrode 30 vertical to the flat plate electrode 39 and the thin line electrode is connected with the thundercloud charge gathering and eliminating unit 2. An appropriate ionization discharging gap is maintained between the flat plate electrode 39 and the cylindrical thin line electrode 30 vertical to the flat plate electrode 39.

The embodiment in FIG. 8B is similar to the strong-ionization discharging unit in FIG. 8A, showing the schematic diagram that the vertical cylindrical thin line electrode is set vertical to the plate electrode and is connected with the grounding conductor 4; As shown in the figure, the described electrode A of the strong-ionization discharging unit is the flat plate electrode 39, which is electrically connected with the thundercloud charge gathering and eliminating unit 2; Another electrode B is the cylindrical thin line electrode 30 vertical to the plate electrode 39 and the thin line electrode is connected with the grounding conductor 4. An appropriate ionization discharging gap is maintained between the flat plate electrode 39 and the cylindrical thin line electrode 30 vertical to the flat plate electrode 39.

In the embodiments shown in FIG. 8A and FIG. 8B, in order to further increase the voltage breakdown level between the two electrodes, according to the needs, the insulating dielectric layer can be inserted in the gap between the flat plate electrode 39 and the cylindrical thin line electrode 30 vertical thereto.

The strong-ionization discharging unit of the invention can also be a spherical electrode; One spherical electrode is electrically connected with the thundercloud charge gathering and eliminating unit 2, and another spherical electrode is electrically connected with the grounding conductor 4.

In order to improve the effect of ionization discharge, in some embodiments, the thundercloud charge gathering and eliminating unit is a lightning-eliminating array. The lightning eliminating array can either be the LEA of American-style with multi short-rods or the LEA of Chinese-style with less long-rods.

The lightning-eliminating array comprises an arc-cover base and a dozen to hundreds of array rods; these array rods are mounted on the outer wall of the base. The array rod can be a metal solid rod or a metal hollow tube.

FIG. 4 is the schematic diagram of installation structure of the thundercloud charge gathering and eliminating unit and the strong-ionization discharging unit of the invention. As shown in the figure, the lightning eliminating array comprises one base and several array rods; The array rods are mounted on the outer wall of the base and the array rods are hollow metal tubes; a discharging space is formed within the base, and the described electrode A of the strong-ionization discharging unit is combined into one with the lightning eliminating array rods and base and is installed in the discharging space with another electrode B of the ground conductor; The base is fixed on the electrode seat of the electrode B through the insulating supporter and then fixed on the lightning rejection tower through the electrode seat.

The bottom of the base is provided with an open inlet, and the updraft enters the base along the inlet, flowing through the discharge electrodes and being exited to the space through the outlet of each array rods and tubes. The air passages are interconnected between the inlet, the strong-ionization discharging space and the hollow tubes of each array rods, the airflow channel is suitable for accelerating the inhalation of more updraft to ionize and outputting the ionized gas to the metal tips end of the array rods for re-ionizing and dissipating to produce more dissipation current.

The passive compound strong-ionization discharging plasma lightning rejection device of the invention neutralizes the thundercloud charges through the strong-ionization discharging unit 3 and in the way of strong-ionization discharging; in the meanwhile, the strong-ionization discharging unit 3 produces plasma by ionizing the air around it during the discharging process. It doesn't need artificial power supply in the process of air ionization, but uses the energy provided by the thundercloud electric field to ionize the air from the atmosphere and efficiently produce high density plasma. The indexes of ion density, ionizing degree and ion instantaneous producing rate are greatly superior to those achieved by active plasma generator. For instance, the key indicator—dissipation current is about 600 times that of the active plasma generator and then ensures its reliable lightning rejecting passively. In the test operation of the prototype PLR in heavy lightning strike areas, the lightning stroke risk is monitored with lightning fore-alarm and the lightning rejection function of PLR is monitored with lightning stroke counter. In the wide protection range of the protection angle greater than 84°, the records of successfully rejecting lightning without failure have reached for thousands of times.

A variety of simulation tests have been carried out for the invention. In one of the tests, when the thunder-cloud electrode plate is supplied with strong electric field strength and the conventional LR maintains strong brush-discharging as its electric field strength is increased by about 1000 times due to the point effect on its tip, move a LPR into any position under the thundercloud electrode plate, then the LR immediately stops discharging and there is also no discharging between the PLR and the thundercloud electrode plate either. It shows that PLR is able to protect the objects like LR with the highest induced electric field strength and PLR itself from lightning stroke under the whole thundercloud electrode plate. With the strong ionization discharging, PLR can reach the charge dissipating rate of 30 mC/s (i.e. 30 mA dissipating current), i.e., in 5.6 minutes it can neutralize 10C charges at the bottom of the thundercloud and then effectively restrains the intensification of thundercloud electric field and the formation and development of the lightning leader and realizes the lightning rejection with non-lightning-breakdown to the ground by the way of slow leaking and neutralizing the charges at the bottom of the thundercloud.

The above descriptions are the typical embodiments according to the conception and working principle of the invention as well as by implementing the idea and working principle of the invention. The above embodiments should not be construed as the limitation of the conception and working principle of the invention. Other embodiments and examples in accordance with the idea of the invention as well as the combination of embodiments and examples all belong to the protection scope of the invention.

1. A passive compound strong-ionization discharging plasma lightning rejection device comprises a thundercloud charge gathering and eliminating unit, a strong-ionization discharging unit and a grounding conductor, wherein discharging electrodes of the strong-ionization discharging unit comprise two electrodes, an electrode A being connected with the thundercloud charge gathering and eliminating unit, an electrode B being connected to the grounding conductor, and a discharging gap between the two electrodes being separated and fixed by an insulating supporter; the thundercloud charge gathering and eliminating unit is a lightning eliminating array.

2. The lightning rejection device of claim 1, wherein the electrode A of the discharging electrode of the strong-ionization discharging unit is an arc surface electrode, a flat plate electrode, a thin line electrode or an annular electrode, and wherein the electrode B is a arc surface electrode, a flat plate electrode, a thin line electrode or an annular electrode, an edge of the plate electrode has a circular arc shape that eliminates intensification effect of edge electric field.

3. The lightning rejection device of claim 2, wherein the annular electrode A is an annular plate electrode, an annular arc surface electrode or an annular thin line electrode, and wherein the electrode B is an annular plate electrode, an annular arc surface electrode or an annular thin line electrode; the annular electrode A and the annular electrode B are concentric rings, an edge of the annular plate electrode has a circular arc shape that eliminates intensification effect of edge electric field.

4. The lightning rejection device of claim 2, wherein the electrode A and electrode B are thin line electrodes; the thin line electrode is a circular single loop or multi-loop thin line, and a cross section arc radius R of the thin line electrode in a form of a circular single loop is about 0.1 mm˜10 mm.

5. The lightning rejection device of claim 2, wherein the electrode A and electrode B are thin line electrode, the thin line electrode is a linear protrusion provided on a plate plane of the flat plate electrode and the arc electrode, the linear protrusion is a fine circular line, a semicircle line, a tooth tip line, a cross section line of a thin plate or an edge angle line of a thick plate, and wherein the cross section arc radius R of the linear protrusion is 0.1 mm˜10 mm, causing thin line effect in ionizing discharging; the thin line electrode is axially perpendicular to the plate electrode, with equivalent effect of a tip electrode axially perpendicular to the plate electrode.

6. The lightning rejection device of claim 2, wherein the electrode A is a multi-thin line electrode, the electrode B is a flat plate electrode or an arc plate electrode and an axis of the multi-thin line electrode is perpendicular to the flat plate electrode or perpendicular to the normal of the curved plate electrode; an edge of the flat plate electrode or the arc plate electrode has a circular arc shape that eliminates intensification effect of edge electric field.

7. The lightning rejection device of claim 1, wherein the additional insulating dielectric layer can be added between the electrode A and electrode B of the strong-ionization discharging unit and wherein the dielectric layer further increases the gap breakdown voltage.

8. The lightning rejection device of claim 1, wherein the lightning-eliminating array comprises an arc cover-shaped base and a dozen to hundreds of array rods; the array rods are mounted on the outer wall of the base; the array rods can be a metal solid rod or a metal hollow tube.

9. The lightning rejection device of claim 7, wherein the lightning-eliminating array comprises an arc cover-shaped base and a dozen to hundreds of array rods; the array rods are mounted on the outer wall of the base; the array rods can be a metal solid rod or a metal hollow tube.

10. The lightning rejection device of claim 8, wherein the base is a hollow arc metal cover, the described discharge electrode of the strong-ionization discharging unit is installed in the cover and the inner wall of the base is one pole of the discharging electrode of the strong ionization discharging unit; the base is fixed on the other electrode seat of the discharge electrodes of the strong ionization discharging unit through an insulating supporter; the discharging electrode is fixed on the lightning rejection tower in a seat structure, a bottom of the base is provided with an inlet, and atmospheric updraft enters the base along the inlet, flowing through the discharge electrodes and being exited to the space through the outlet of each array tube rods.
